(19) United States
(12) Patent Application Publication
(10) Pub. No.: US 2004/0181396 A1
(43) Pub. Date: Sep. 16, 2004

(54) Nasal sound detection method and apparatus thereof

(76) Inventors: Guoshe Lee, Hualien City (TW); Terry B.J. Kuo, Ji-An Township (TW)

Correspondence Address: SEYFARTH SHAW, 55 EAST MONROE STREET, SUITE 4200, CHICAGO, IL, 60603-5803, US

(21) Appl. No.: 10/687,026

(22) Filed: Oct. 16, 2003

(30) Foreign Application Priority Data
Mar. 12, 2003 (TW) 092105437

(51) Int. Cl. G06F 17/28

(52) U.S. Cl. 704/205; 704/6

(57) ABSTRACT

The variation of a Voice Low-frequency to High frequency Ratio (VLHR) can be analyzed to determine whether a nasal sound occurs for clinical correction and remedy, or as a reference for voiceprint comparison. The VLHR can be obtained by the following steps of (1) capturing a voice signal and digitally sampling the voice signal; (2) transforming the voice signal into a frequency domain signal by Fourier transformation to obtain the fundamental frequency of the voice signal, which can be obtained by auto-correlation also; (3) multiplying the fundamental frequency by a ratio factor to calculate a divisional frequency so as to divide the frequency band of the voice signal into a low-frequency band and a high-frequency band; (4) respectively adding the powers of the frequencies within the low-frequency band and that of the high-frequency band to calculate the power of the low-frequency band and the power of the high-frequency band; (5) calculating the VLHR, which is the ratio of the power of the low-frequency band to the power of the high-frequency band.

### BACKGROUND OF THE INVENTION

(A) Field of the Invention

The present invention is related to a nasal sound detection method and apparatus thereof, more specifically, to a nasal sound detection method and the apparatus employing a Voice Low-Frequency to High-Frequency Ratio (VLHR).

(B) Description of the Related Art

Languages like Chinese, English, or others, all include considerable nasal phonemes, such as the Chinese phonetic symbols / [symbol] /, / [symbol] /, / [symbol] /, and the English phonetic symbols /m/, /n/, and / [symbol] /. A nasal sound articulation of a human being is by the incorporation of an oral cavity, a tongue, and a velum to pass the voice to the nasal cavity through the velum. The nasal sound originates from the resonance of the voice in the nasal cavity. When the nasal cavity is not stuffed-up, the voice will normally emit from the nasal cavity and be interpreted by the human ear as a nasal sound. However, when the nasal cavity is stuffed-up, the voice is hindered from being emitted from the nose, or the voice cannot even be emitted from the nose, causing a distortion of the phonemes. If a nasal sound is overly generated by the nose due to illnesses, such as a cleft lip palate, it is clinically called hypernasality. On the contrary, if the output of the nasal sound is less than that of a normal person, e.g., caused by a nasal congestion, it is clinically known as hyponasality. Accordingly, the intensity of the nasal sound is relevant to the conditions of the nasal cavity.

In the case of a stuffy nose, in addition to the diminution of nasal sounds, the nasal vowels, / [symbol] / and / [symbol] /, will disappear, inducing communication problems.

In conventional diagnosis of a patient, a physician has to listen to the sound emitted from the patient or examine the nasal cavity of the patient. Basically, the conventional method entirely depends on the experience of the physician. However, when a diagnosis is in process, the environment, such as ambient noise, the physical or mental condition of the physician, and the extent of the cooperation of the patient, all affect the result of the diagnosis. Hence, an objective nasal sound detection method and the apparatus can assist the physician to more accurately diagnose their patients so as to prevent misdiagnosis.

### SUMMARY OF THE INVENTION

The objective of the present invention is to provide a nasal sound detection method and apparatus thereof to distinguish nasal components from non-nasal components in a voice for clinical remedy or treatment, or for the basis of voiceprint comparison.

Followed by the opening of the velum, a voice is generated through resonance arising in a vocal tract, which comprises the throat, pharynx, oral cavity and nasal tract. The voice has a minimum formant, namely fundamental frequency, in the spectrum, whereas the other formants are the multiples of the fundamental frequency. The present invention employs a parameter called, Voice Low-Frequency to High-Frequency Ratio (VLHR), derived from the analysis of fundamental frequency, and then analyzes the variation of the VLHR to be an auxiliary reference for voice correction.

To achieve the objective mentioned above, a nasal sound detection method is provided, which comprises the following steps of (1) capturing a voice signal and digitally sampling the voice signal; (2) transforming the voice signal into a frequency domain signal by Fourier transformation. The fundamental frequency of the voice signal can be obtained by auto-correlation also; (3) multiplying the fundamental frequency by a ratio factor to calculate a divisional frequency so as to divide the frequency band of the voice signal into a low-frequency band and a high-frequency band; or the divisional frequency can be determined to specific values, e.g. 600 Hz, for various phonation status (4) respectively adding the powers of the frequencies within low-frequency band and that of the high-frequency band to obtain the power of the low-frequency band and the power of the high-frequency band; (5) calculating the VLHR, which is the ratio of the power of the low-frequency band to the power of the high-frequency band. By analyzing the changes of the VLHR, the nasal sound detection and the voiceprint comparison can be performed for voice correction or identification recognition.

The above-mentioned fundamental frequency may be selected from the first formant frequency of the frequency domain signal. The ratio factor is the square root of the product of the adjacent integers, e.g., 2 and 3, or 3 and 4. In such case, the divisional frequency is equal to that of the fundamental frequency multiplied by \sqrt{6} or \sqrt{12}.

A microphone, a computer, and a monitor are employed to carry out the nasal sound detection mentioned above, in which the computer comprises an audio capture card and a program. After the microphone has captured a voice signal, the voice signal is digitally sampled by the audio capture card, and then the fundamental frequency and the divisional frequency of the voice signal are calculated in accordance with the program so as to obtain the VLHR of the voice signal. Finally, the changes of the VLHR are displayed on the monitor for analysis.

### BRIEF DESCRIPTION OF THE DRAWINGS

FIG. 1 illustrates the nasal sound detection apparatus of the present invention;

FIGS. 2 to 4 illustrate the method to obtain the VLHR of the present invention;

FIG. 5 illustrates a test example in accordance with the nasal sound detection method of the present invention; and

FIG. 6 is the flowchart of the nasal sound detection method of the present invention.

### DETAILED DESCRIPTION OF THE INVENTION

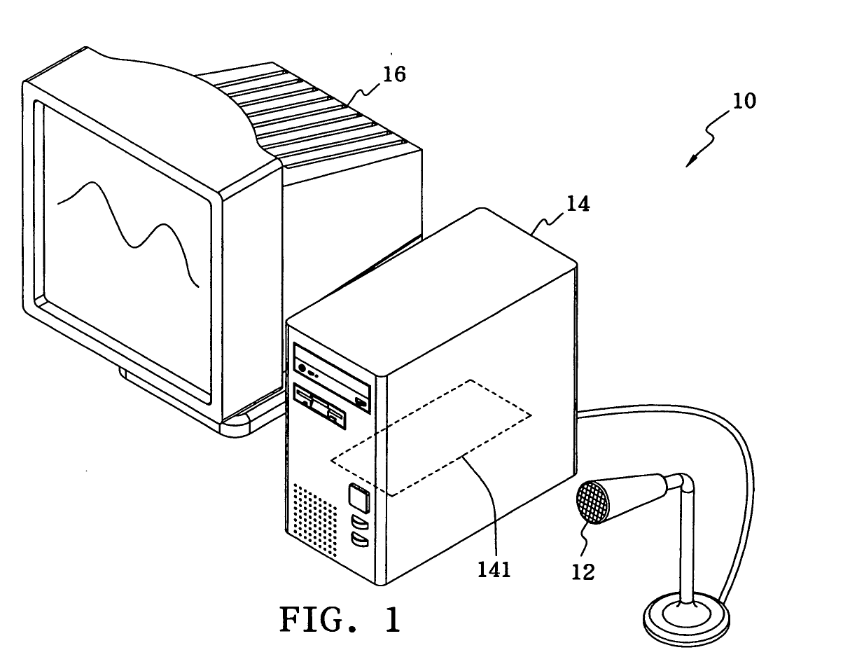

As shown in FIG. 1, a highly sensitive dynamic microphone 12 is connected to a computer 14 to constitute a nasal sound detection apparatus 10, and an audio capture card 141 inside the computer 14 is employed for digitally sampling the voices. The computer 14 is able to process real-time Fourier transformations of a voice signal to meet the demand for massive data processing. The computer 14 can run a program to transform a voice signal into a signal of the frequency domain, so as to calculate the fundamental frequency and the divisional frequency of the voice signal to further obtain the VLHR, which is displayed on a monitor 16 for real-time monitoring and articulation correction. In the embodiment, the computer 14 uses the Athlon 850 MHz Central Processing Unit (CPU) together with a Microsoft Windows 98 operating system to conduct the experiment.

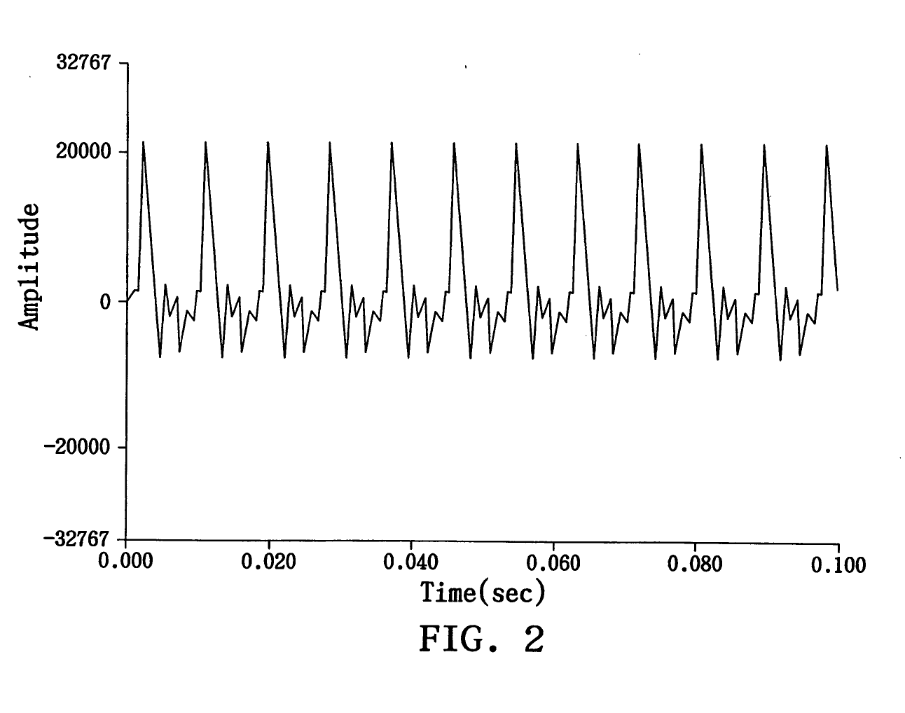

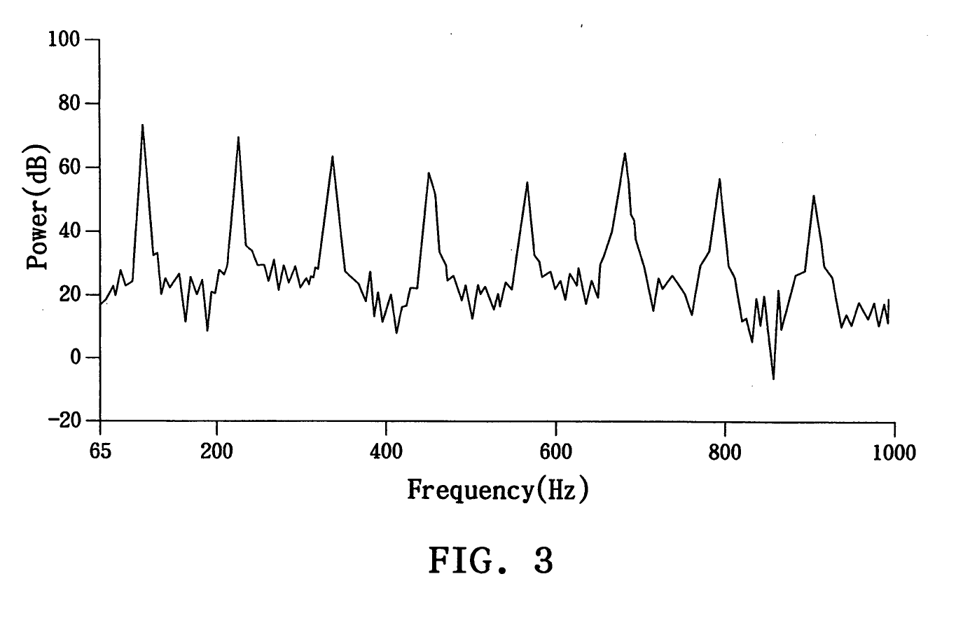

A voice signal is originally depicted as a diagram of amplitude against time, that is, a time domain diagram. FIG. 2 is the time domain diagram of the vowel, /a/, wherein the ordinate represents the amplitude of the voice, the abscissa represents the time, and the sampling frequency is 22 kHz. In practice, it is recommended that the sampling frequency of a voice should not be less than 20 kHz. Sequentially, by applying Fourier transformation, the time domain diagram of the voice signal as shown in FIG. 2 is transformed into the frequency domain diagram in FIG. 3 to facilitate subsequent analysis. In FIG. 3, the ordinate and the abscissa represent power and frequency, respectively. The Fourier transformation is carried out more than 10 times per second, and the resolution of the frequency of the Fourier transformation is approximately 10 Hz, i.e., the curve of the frequency domain diagram is plotted with the powers taken at every 10 Hz. The first formant in FIG. 3 is located around the frequency of 113 Hz, which can be chosen as the fundamental frequency of the voice signal. Moreover, the fundamental frequency can also be acquired by auto-correlation. The number of the fundamental frequency multiplied by a ratio factor is defined as a divisional frequency, and the ratio factor is \sqrt{m×n}, or its multiples, wherein m and n are adjacent integers. In general, the divisional frequency should be of relatively low power, and experience shows that adjacent integers such as m=2 and n=3, or m=3 and n=4, are preferred. In other words, the divisional frequency can be obtained via multiplying the fundamental frequency by \sqrt{6} or \sqrt{12}. The divisional frequency can be determined to specific values, such as a frequency between 500-2100 Hz, on various phonation conditions

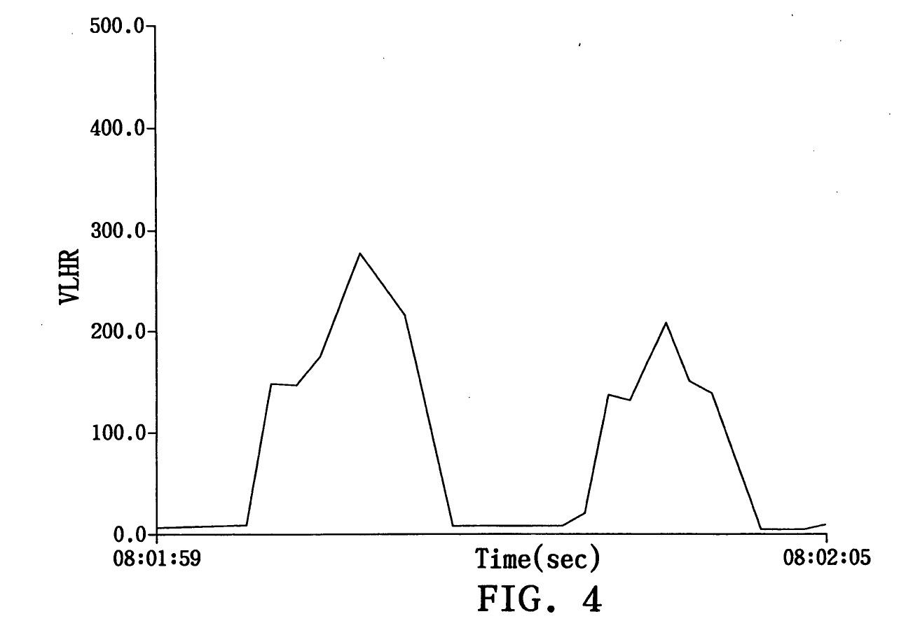

The frequency spectrum of a voice can be divided into a low-frequency band and a high-frequency band according to the divisional frequency. In FIG. 3, the low-frequency band is between 65 Hz and the divisional frequency, whereas the high-frequency band is between the divisional frequency and 1000 Hz. The power of the low-frequency band and the power of the high-frequency band can be obtained by respectively adding up the powers of the frequencies within the low-frequency band and that of the high-frequency band. The ratio of the power of the low-frequency band to the power of the high-frequency band is the VLHR. FIG. 4 is a diagram of the VLHR against time.

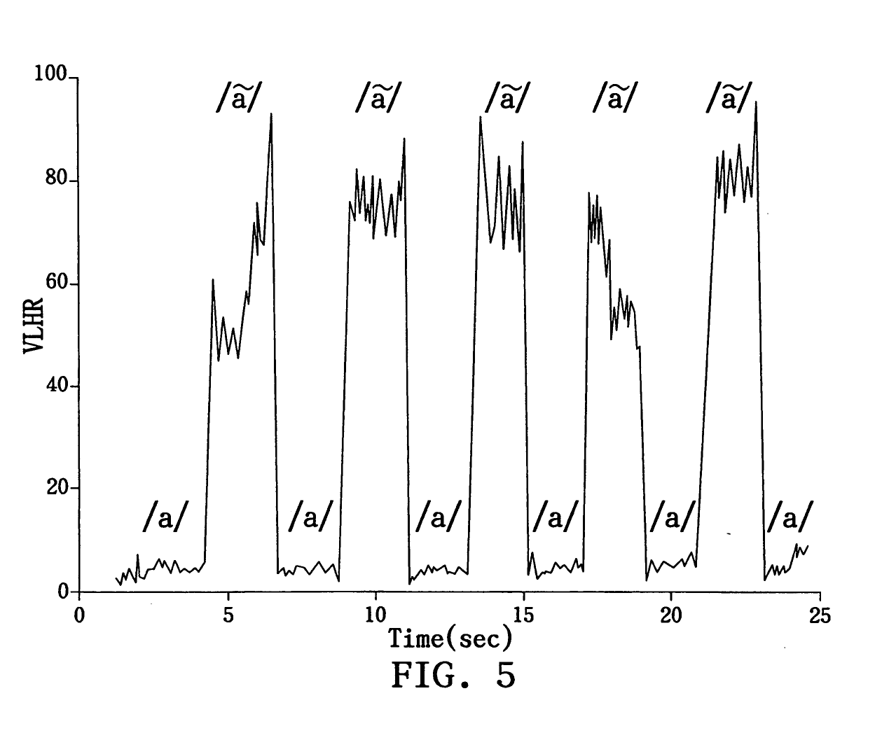

FIG. 5 is a diagram showing the VLHR that arises from the pronunciation of alternate the vowel, /a/, and the corresponding nasal sound, /ã/. As shown in FIG. 5, there is a great difference between the VLHR of /a/ and that of /ã/, indicating that there is a great change in VLHR after a vowel was nasalized. At least, it is a fact to the vowel, /a/.

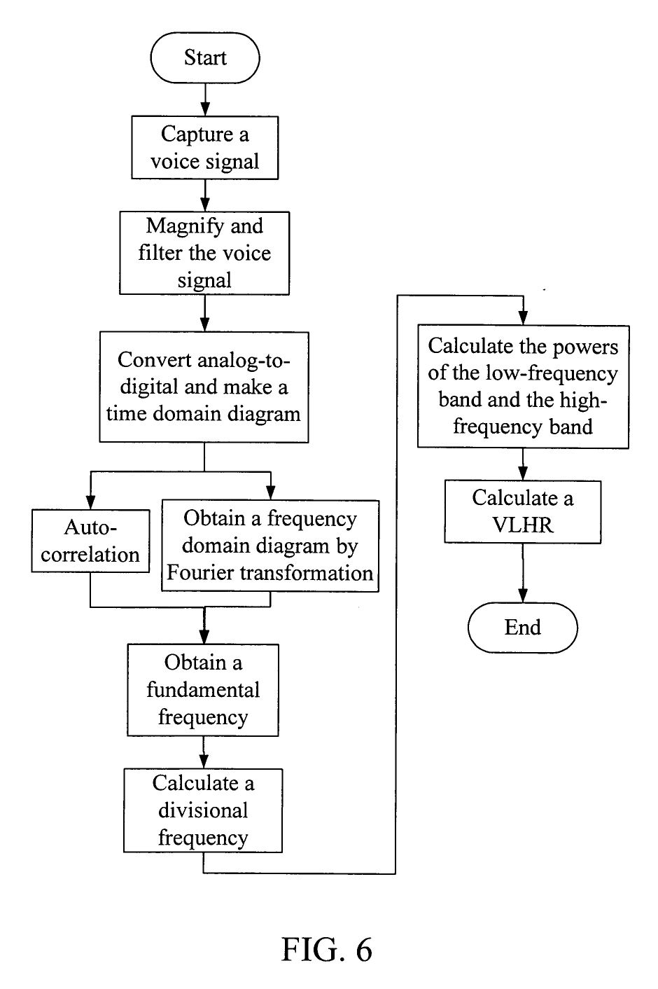

FIG. 6 is a flowchart of the nasal sound detection put forth by the present invention. First, a highly sensitive dynamic microphone is employed to capture a voice signal, which is then magnified and filtered. Afterwards, the voice signal, which is originally analog, is digitally sampled and the time domain diagram of the voice signal is plotted. Sequentially, the power of every frequency band of the voice signal is calculated by means of Fourier transformation to produce the frequency domain diagram, and the first formant of the frequency domain diagram is selected as the fundamental frequency. Moreover, the fundamental frequency can also be acquired through the peak values of a related curve of the time domain signal by auto-correlation. The divisional frequency, equal to that of the fundamental frequency multiplied by the square root of the product of adjacent integers, is the dividing line of the high frequency band and the low frequency band. Adding up the powers of the frequencies within the low-frequency band and that of the high-frequency band, so as to obtain the power of the low-frequency band and the power of the high-frequency band, the power of the low-frequency band is divided by the power of the high-frequency band to obtain the VLHR.

According to the above-mentioned experiment, the VLHR can reflect the properties of a nasal sound. A nasal sound accompanies a higher VLHR. On the contrary, a non-nasal sound accompanies a lower VLHR. Therefore, the VLHR can be employed to quantify the nasal sounds of a voice. Inappropriate nasal sounds may raise difficulties in voice recognition, that is, difficulties in comprehension, resulting in communication barriers. It can be determined whether the nasal sounds are appropriate by real-time monitoring of the VLHR changes during articulation, so as to correct the articulation by taking various remedies in time.

Although the VLHR may vary with different divisional frequencies, the statistic of VLHRs can be a reference for various vowels. No matter whether a voice contains a nasal sound, a voice that falls out of the allowed range of the standard value of the VLHRs is deemed an articulation abnormality. Therefore, the method and apparatus of the present invention can be used as an auxiliary tool for real-time speech remedy.

The VLHR can also function as an index for the recognition of different nasal sounds for the sake of speech recognition. Moreover, in the applications of an artificial synthetic voice such as a cochlear implant, the VLHR is considered an important index. When a voice becomes louder or quieter, the VLHR should be unchanged because of the same properties of the vowel components and the nasal components of the voice.

Every person may have a different nose structure, so the VLHR of every vowel will also be different. In other words, a different VLHR stands for a different articulator. Therefore, if a database of the VLHRs of people is built-up, it is feasible to employ voiceprinting comparison for identification recognition.

The above-described embodiments of the present invention are intended to be illustrative only. Numerous alternative embodiments may be devised by those skilled in the art without departing from the scope of the following claims.

What is claimed is:

1. A nasal sound detection method, comprising the steps of:
capturing a voice signal;
calculating a fundamental frequency of the voice signal;
calculating a divisional frequency based on the fundamental frequency to divide the voice signal into a high-frequency band and a low-frequency band;
calculating powers of the high-frequency band and the low-frequency band; and
calculating a voice low-frequency to high-frequency ratio (VLHR) based on the ratio of the power of the high-frequency band to the power of the low-frequency band.

2. The nasal sound detection method of claim 1, wherein the fundamental frequency is a first formant frequency in frequency domain transformed from the voice signal by Fourier transformation.

3. The nasal sound detection method of claim 1, wherein the divisional frequency is the product of the fundamental frequency and a ratio factor.

4. The nasal sound detection method of claim 1, wherein the divisional frequency is between 500-2100 Hz.

5. The nasal sound detection method of claim 1, wherein the power of the low-frequency band and the power of the high-frequency band are the sum of the powers of frequencies within the low-frequency band and the sum of the powers of frequencies within the high-frequency band, respectively.

6. The nasal sound detection method of claim 3, wherein the ratio factor is a square root of a product of adjacent integers.

7. The nasal sound detection method of claim 3, wherein the ratio factor is one of \sqrt{6} and \sqrt{12}.

8. The nasal sound detection method of claim 1, wherein the sampling frequency of the voice signal is not smaller than 20 KHz.

9. The nasal sound detection method of claim 2, wherein the frequency of Fourier transformation is larger than 10 times per second.

10. A nasal sound detection apparatus, comprising:
a microphone for capturing a voice signal;
a computer, including:
an audio capturing card for digitally sampling the voice signal; and
a program for calculating a fundamental frequency and a divisional frequency of the voice signal so as to calculate a VLHR of the voice signal; and
a monitor for displaying the variation of the VLHR.

11. The nasal sound detection apparatus of claim 10, wherein the program employs Fourier transformation to transform the voice signal into a frequency domain signal so as to calculate the fundamental frequency and the divisional frequency of the voice signal.

12. The nasal sound detection apparatus of claim 10, wherein the sampling frequency of the audio capturing card is not smaller than 20 KHz.

13. The nasal sound detection apparatus of claim 11, wherein he frequency of the Fourier transformation is larger than 10 times per second.
